(19) United States
(12) Patent Application Publication
(10) Pub. No.: US 2026/0098445 A1
(43) Pub. Date: Apr. 9, 2026

(54) METHODS AND SYSTEMS FOR CONTROLLING SUNLIGHT IN RETROFITTED OFFICE BUILDINGS CONVERTED TO RESIDENTIAL USE

(71) Applicant: Gal EHRLICH, Tel-Aviv (IL)

(72) Inventor: Gal EHRLICH, Tel-Aviv (IL)

(21) Appl. No.: 19/221,577

(22) Filed: May 29, 2025

Related U.S. Application Data
(63) Continuation of application No. 18/910,097, filed on Oct. 9, 2024, now abandoned.

(51) Int. Cl. E06B 9/68; E06B 9/24; E06B 9/28; E06B 9/36

(52) U.S. Cl. CPC E06B 9/68; E06B 9/28; E06B 9/36; E06B 2009/2423; E06B 2009/2464; E06B 2009/2476; E06B 2009/6827

(57) ABSTRACT

A method and system for retrofitting an office building into residential units by installing controllable sun-shielding elements on the facade, which may integrate photovoltaic cells to assist in energy supply while blocking sunlight when needed. These sun-shielding elements, such as darkening glass panels or adjustable blinds with photovoltaic cells, are controllable by occupants of each residential unit to selectively allow or block sunlight entering their units. The system enhances comfort, energy efficiency, and aesthetic appeal, and can be integrated with building management systems, climate control, and emergency systems.

### RELATED APPLICATION

This application is a continuation of U.S. patent application Ser. No. 18/910,097 filed on Oct. 9, 2024, the contents of which are incorporated herein by reference in their entirety.

### FIELD OF THE INVENTION

The present invention relates generally to building retrofitting methods and systems, and more particularly to methods and systems for controlling sunlight in office buildings that have been converted into residential units. This involves installing controllable sun-shielding elements on the facade of the building, which may integrate photovoltaic cells to assist in energy supply while blocking sunlight when needed, allowing occupants of each residential unit to selectively allow or block sunlight entering their respective units.

### BACKGROUND OF THE INVENTION

As urban populations continue to grow, there is an increasing demand for residential housing in city centers. Concurrently, many office buildings are becoming obsolete due to changes in work patterns, such as remote work and flexible scheduling. Converting these underutilized office buildings into residential units presents a practical solution to address housing shortages and revitalize urban areas.

Office buildings are typically designed to maximize natural light exposure, featuring large windows and facades optimized for sunlight capture. While this design is advantageous for commercial spaces, it can present challenges when the building is converted into residential use. Excessive sunlight can lead to discomfort for residents, causing issues such as overheating, glare, and lack of privacy. Traditional methods of controlling sunlight, such as curtains or interior blinds, may not be sufficient or aesthetically pleasing in a residential context.

Moreover, the facades of modern office buildings offer an opportunity to enhance energy efficiency through the integration of photovoltaic cells. By converting sunlight into electricity, photovoltaic cells can provide a renewable energy source for the building. However, integrating such technology into existing structures without significant structural modifications poses a challenge.

Therefore, there is a need for a method and system that allows residents to effectively control the amount of sunlight entering their units, enhances the building's energy efficiency through the integration of photovoltaic cells, and contributes to the building's aesthetic appeal, all while complying with architectural and regulatory standards.

### SUMMARY OF THE INVENTION

The present invention provides methods and systems for retrofitting office buildings converted into residential units by installing sun-shielding elements on the building's facade. These sun-shielding elements are controllable by occupants of each residential unit, allowing them to selectively allow or block sunlight entering their respective units. Furthermore, the sun-shielding elements may integrate photovoltaic cells to assist in energy supply to the building while blocking sunlight when needed.

In one embodiment, the sun-shielding elements comprise darkening glass panels that adjust transparency in response to control signals from the occupants. In another embodiment, the sun-shielding elements comprise blinds installed on the facade, operable to adjust the amount of sunlight entering the residential units. The blinds can be vertical blinds, horizontal blinds, or a combination thereof, and are controllable by the occupants.

The sun-shielding elements may be motorized and integrated with a control interface within each residential unit. They are designed to contribute to the decorative appearance of the building facade. The method further comprises integrating the sun-shielding elements with an automated building management system to control sunlight exposure based on environmental conditions.

In some embodiments, the sun-shielding elements include a combination of darkening glass and adjustable blinds. The darkening glass panels may be made of electrochromic glass that changes transparency upon application of an electric voltage. The sun-shielding elements provide thermal insulation to the residential units and may include individual control interfaces within each residential unit to operate the sun-shielding elements.

The sun-shielding elements can be installed over existing windows of the building facade or comprise external shading devices attached to the facade, such as adjustable louvers controllable by the occupants. They can be programmable to automatically adjust based on the time of day and may integrate sensors to detect sunlight intensity and adjust accordingly.

The sun-shielding elements may include smart glass technology responsive to electrical, thermal, or optical stimuli. Remote control capabilities via mobile devices can be provided. They are designed to improve the energy efficiency of the building by reducing cooling loads and may reduce glare inside the residential units.

The sun-shielding elements can be integrated with the building's climate control system to optimize indoor temperatures. In addition, the facade may integrate photovoltaic cells installed on or within the sun-shielding elements to generate electricity, assisting in energy supply to the building while blocking sunlight when needed. This dual functionality enhances the building's sustainability and energy efficiency.

Enhanced privacy is provided by the sun-shielding elements, which can reduce visibility into the residential units from the exterior. In case of emergencies, the sun-shielding elements can be integrated with an emergency system to automatically open, ensuring compliance with safety regulations and facilitating evacuation if necessary.

### BRIEF DESCRIPTION OF THE SEVERAL VIEWS OF THE DRAWING(S)

FIG. 1 illustrates a perspective view of a retrofitted residential building with controllable sun-shielding elements integrating photovoltaic cells installed on the façade.

FIG. 2 shows a cross-sectional view of a residential unit with sun-shielding elements comprising darkening glass panels and integrated photovoltaic cells.

FIG. 3 depicts a block diagram of the control system for the sun-shielding elements and photovoltaic cells within a residential unit.

FIG. 4 presents a detailed view of external adjustable louvers with integrated photovoltaic cells attached to the building façade.

FIG. 5 illustrates the electrical integration of photovoltaic cells into the building's energy supply system.

### DESCRIPTION OF SPECIFIC EMBODIMENTS OF THE INVENTION

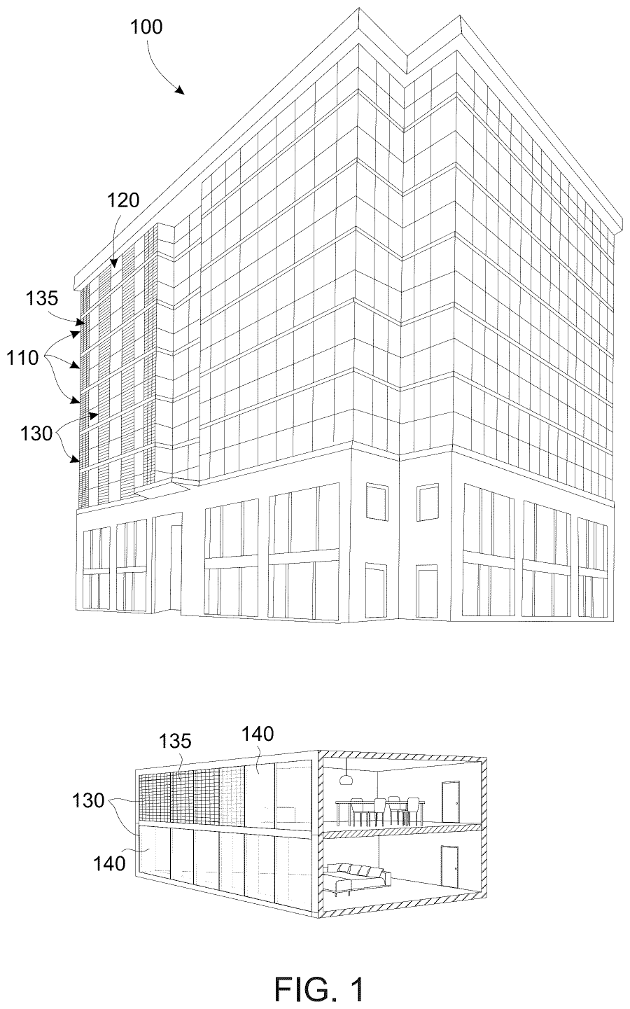

Referring to FIG. 1, an office building 100 converted into residential units 110 features a facade 120 equipped with sun-shielding elements 130 that integrate photovoltaic cells 135. These elements are controllable by occupants of each residential unit to selectively allow or block sunlight entering their respective units while generating electricity to assist in energy supply to the building.

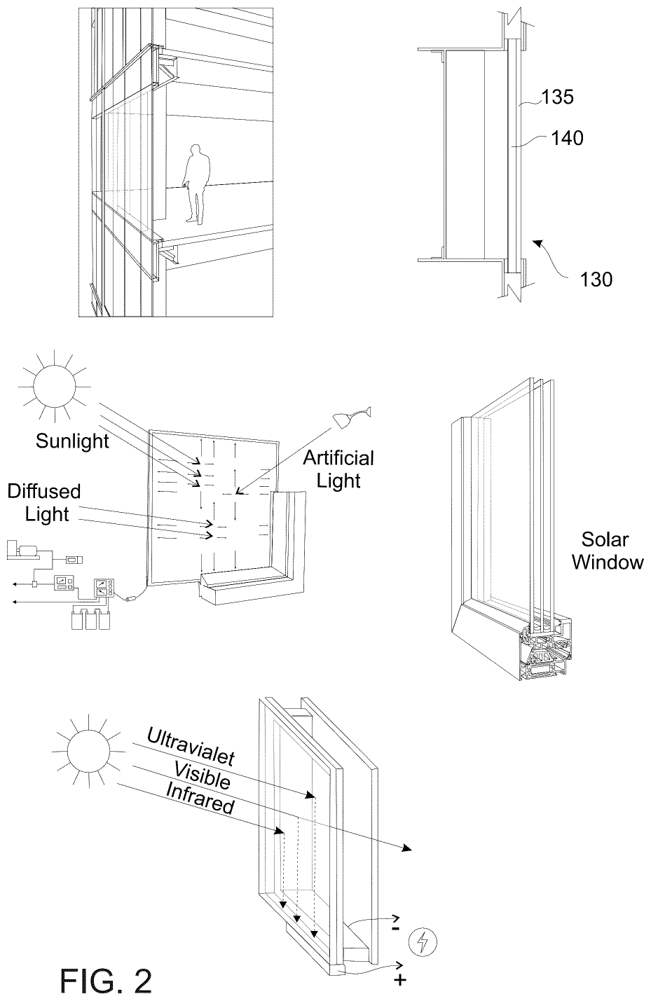

In one embodiment shown in FIG. 2, the sun-shielding elements 130 comprise darkening glass panels 140 that adjust transparency in response to control signals from the occupants. The darkening glass panels 140 are made of electrochromic materials that change transparency upon application of an electric voltage. Photovoltaic cells 135 are integrated into or adjacent to these panels, allowing for simultaneous control of sunlight and generation of electricity. The photovoltaic cells 135 can be thin-film solar cells embedded within the glass layers or attached to the exterior surface.

The integration of photovoltaic cells 135 into the sun-shielding elements 130 serves a dual purpose. Firstly, it provides renewable energy generation by converting sunlight into electricity, which can be used to power common areas, reduce the building's overall energy consumption from the grid, or supply energy back to the units. Secondly, the photovoltaic cells 135 act as a shading device, reducing the intensity of sunlight entering the residential units 110, thereby decreasing cooling loads and enhancing occupant comfort.

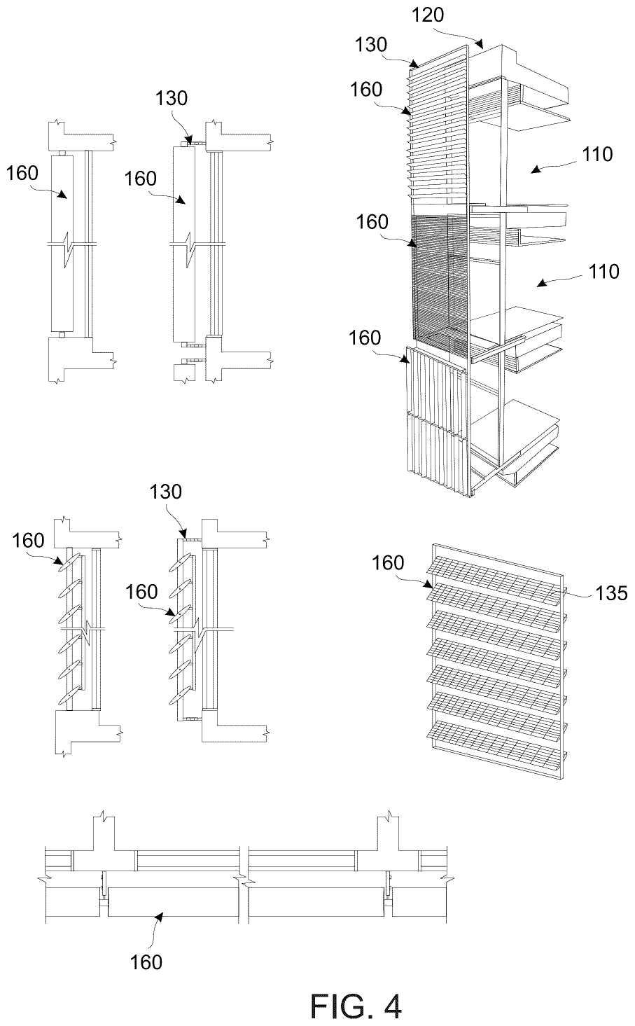

Alternatively, as depicted in FIG. 4, the sun-shielding elements 130 comprise external shading devices 150 attached to the facade 120. These devices may be adjustable louvers 160 equipped with photovoltaic cells 135 on their surfaces. The adjustable louvers 160 are operable by the occupants through control interfaces 170 within each residential unit 110. The louvers can be rotated or tilted to optimize sunlight blocking and energy generation, depending on the position of the sun and the occupants' preferences.

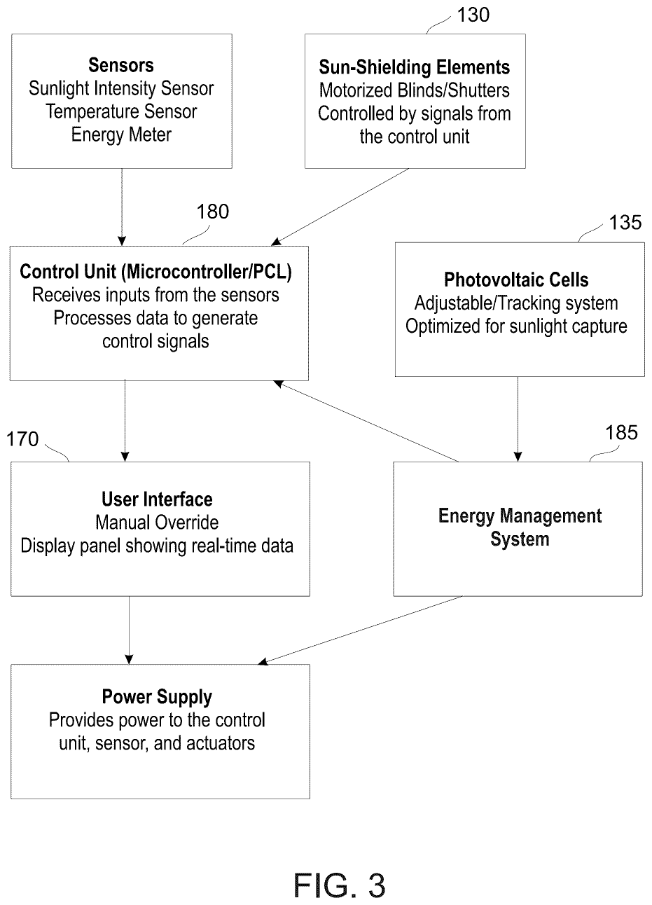

FIG. 3 illustrates the control system 180 for the sun-shielding elements 130 and integrated photovoltaic cells 135. The system includes individual control interfaces 170 in each residential unit 110, allowing occupants to adjust the sun-shielding elements manually or set automated preferences. The control system 180 is integrated with an energy management system 185 that monitors and manages the electricity generated by the photovoltaic cells 135. This system can allocate the generated energy to specific building functions or feed it back into the grid.

The sun-shielding elements 130 are designed to contribute to the decorative appearance of the building facade 120, enhancing the aesthetic appeal of the building 100. The integration of photovoltaic cells 135 can be aesthetically incorporated into the design, using semi-transparent solar cells or arranging them in patterns that complement the building's architecture. The sun-shielding elements may be customizable in color and pattern for each residential unit 110, allowing for personalization and architectural harmony.

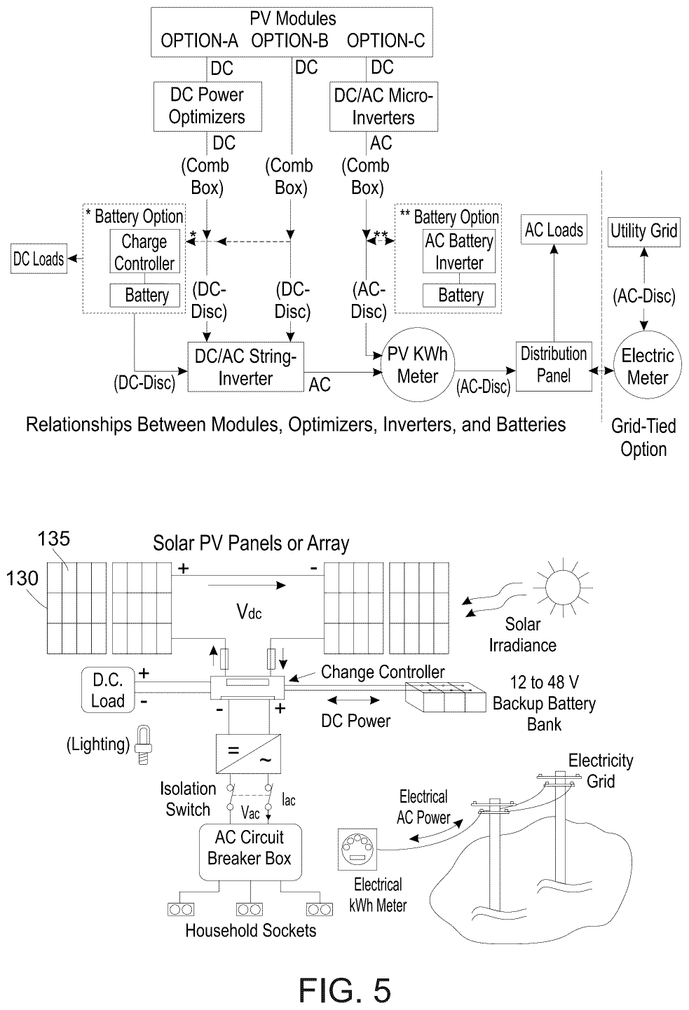

The photovoltaic cells 135 integrated into the sun-shielding elements 130 are made of materials resistant to weathering and ultraviolet radiation, ensuring durability and longevity. They are designed to withstand high wind loads and environmental stress, complying with safety standards and building codes. The electrical connections of the photovoltaic cells 135 are routed through the facade 120 into the building's electrical infrastructure, as shown in FIG. 5.

The sun-shielding elements 130 provide additional thermal insulation, improving the energy efficiency of the building 100 by reducing cooling loads. By blocking excessive sunlight, they reduce the need for air conditioning, while the photovoltaic cells 135 provide renewable energy that can be used to power HVAC systems, lighting, and other electrical loads within the building.

In some embodiments, the sun-shielding elements 130 include smart glass technology responsive to electrical, thermal, or optical stimuli. This technology allows for automatic adjustment of transparency or shading based on environmental factors, enhancing comfort and energy efficiency without occupant intervention. The photovoltaic cells 135 can supply power to the smart glass control systems, creating a self-sustaining unit.

The sun-shielding elements 130 may also include features such as retractable mesh screens or photovoltaic blinds, where the slats of the blinds are made from photovoltaic materials. Integration with the building's climate control system 220 optimizes indoor temperatures and reduces reliance on artificial heating or cooling systems.

Enhanced privacy is provided by the sun-shielding elements 130, which can reduce visibility into the residential units 110 from the exterior. The integration of photovoltaic cells 135 adds an additional layer of privacy by partially obscuring the interior when the cells are positioned over windows.

In case of emergencies, the sun-shielding elements 130 can be integrated with an emergency system 230 to automatically open or adjust, ensuring compliance with safety regulations and facilitating evacuation if necessary. For example, in the event of a fire, the sun-shielding elements 130 can be programmed to retract or become transparent to allow for visibility and access by emergency responders.

Maintenance access to the photovoltaic cells 135 and sun-shielding elements 130 is provided through designed access points or from the interior of the residential units 110. The materials and components are selected for longevity and minimal maintenance requirements.

The integration of photovoltaic cells 135 into the sun-shielding elements 130 enhances the building's sustainability profile, potentially qualifying for green building certifications such as LEED (Leadership in Energy and Environmental Design). The renewable energy generated reduces the building's carbon footprint and operating costs, providing economic and environmental benefits to both the building owners and occupants.

It is to be understood that the present invention is not limited to the embodiments described above but encompasses any and all embodiments within the scope of the following claims. Various modifications to the invention will be apparent to those skilled in the art from the foregoing description. Such modifications are intended to fall within the scope of the appended claims.

The invention has been described in detail with particular reference to certain preferred embodiments, but it will be understood that variations and modifications can be effected within the spirit and scope of the invention. The terminology used herein is for the purpose of description and not limitation.

While specific embodiments of the invention have been illustrated and described, it is understood that the invention is not limited to the precise construction herein disclosed and that various changes and modifications may be made without departing from the scope of the invention as defined in the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for retrofitting an office building into residential units, comprising installing sun-shielding elements on the facade of the building, wherein the sun-shielding elements are controllable by occupants of each residential unit to selectively allow or block sunlight entering their respective units, wherein the sun-shielding elements integrate photovoltaic cells to assist in energy supply to the building while blocking sunlight when needed and wherein the sun-shielding elements comprise blinds installed on the facade, which are operable to adjust the amount of sunlight entering the residential units.

2. The method of claim 1, wherein the sun-shielding elements comprise darkening glass panels that adjust transparency in response to control signals from the occupants.

3. The method of claim 1, wherein the blinds are vertical blinds controllable by the occupants.

4. The method of claim 1, wherein the blinds are horizontal blinds controllable by the occupants.

5. The method of claim 1, wherein the blinds are motorized and integrated with a control interface within each residential unit.

6. The method of claim 1, wherein the sun-shielding elements are designed to contribute to the decorative appearance of the building facade.

7. The method of claim 1, further comprising integrating the sun-shielding elements with an automated building management system to control sunlight exposure based on environmental conditions.

8. The method of claim 1, wherein the sun-shielding elements include a combination of darkening glass and adjustable blinds.

9. The method of claim 2, wherein the darkening glass panels are electrochromic glass that changes transparency upon application of an electric voltage.

10. The method of claim 1, wherein the sun-shielding elements provide thermal insulation to the residential units.

11. The method of claim 1, further comprising installing individual control interfaces within each residential unit to operate the sun-shielding elements.

12. The method of claim 1, wherein the sun-shielding elements are installed over existing windows of the building facade.

13. The method of claim 1, wherein the sun-shielding elements comprise external shading devices attached to the facade.

14. The method of claim 13, wherein the external shading devices are adjustable louvers controllable by the occupants.

15. The method of claim 1, wherein the sun-shielding elements are programmable to automatically adjust based on the time of day.

16. The method of claim 1, further comprising integrating sensors to detect sunlight intensity and adjust the sun-shielding elements accordingly.

17. The method of claim 1, wherein the sun-shielding elements include smart glass technology responsive to electrical, thermal, or optical stimuli.

18. The method of claim 1, further comprising providing remote control capabilities for the sun-shielding elements via mobile devices.

19. The method of claim 1, wherein the sun-shielding elements are designed to improve the energy efficiency of the building by reducing cooling loads.

20. The method of claim 1, wherein the photovoltaic cells are integrated into the surface of the sun-shielding elements.

21. The method of claim 1, wherein the photovoltaic cells are installed adjacent to the sun-shielding elements on the facade.

22. The method of claim 1, further comprising integrating the photovoltaic cells with the building's electrical system to supply generated electricity.

23. The method of claim 1, wherein the photovoltaic cells are thin-film solar cells embedded within the sun-shielding elements.

24. The method of claim 1, wherein the sun-shielding elements comprise adjustable louvers with photovoltaic cells mounted on their surfaces.

25. The method of claim 1, wherein the photovoltaic cells contribute to reducing the building's overall energy consumption from the grid.

26. The method of claim 1, further comprising an energy management system to monitor and control the electricity generated by the photovoltaic cells.

27. The method of claim 1, wherein the integration of photovoltaic cells enhances the aesthetic appearance of the building facade.

28. The method of claim 1, wherein the photovoltaic cells are designed to allow partial light transmission.
